(19) United States
(12) Patent Application Publication
(10) Pub. No.: US 2010/0077912 A1
(43) Pub. Date: Apr. 1, 2010

(54) Fighting Shield

(75) Inventors: Terry Eugene Smith, Keene, NH (US); Thomas P. Lang, Great Barrington, MA (US); Charles M. Howard, Chesire, MA (US); Debra A. Daigneault, Pittsfield, MA (US); Richard A. Carlson, Silverado, CA (US)

Correspondence Address: Kane Kessler P.C., 1350 Avenue of the Americas, 26th Floor, New York, NY, 10019, US

(73) Assignee: Safariland, LLC, Jacksonville, FL (US)

(21) Appl. No.: 12/554,406

(22) Filed: Sep. 4, 2009

Related U.S. Application Data
(60) Provisional application No. 61/094,420, filed on Sep. 5, 2008.

(51) Int. Cl. F41H 5/08; B05B 9/03

(52) U.S. Cl. 89/36.07; 239/302; 89/926

(57) ABSTRACT

A portable shield for use by a peace officer can be carried on an officer's arm and has a curved outer surface and a relatively small overall shape, to provide better enforcement abilities. The shield supports a canister of sprayable protection material, such as pepper spray. The shield has a baton port for supporting an officer's baton during use of the baton.

### RELATED APPLICATION

This application claims the benefit of U.S. Provisional Application No. 61/094,420, filed Sep. 5, 2008, titled Monadnock Fighting Shield. The entire disclosure of that provisional application is incorporated by reference.

### SUMMARY OF THE INVENTION

This invention relates to a shield and, in particular, to a portable shield for use by a peace officer, for example. The shield can be carried on an officer's arm and has a curved outer surface and a relatively small overall shape, to provide better enforcement abilities. The shield may supports a canister of sprayable protection material, such as pepper spray. The shield may have a baton port for supporting an officer's baton during use of the baton.

### BRIEF DESCRIPTION OF THE DRAWINGS

Further features of the invention will become apparent to one of ordinary skill in the art to which the invention pertains upon a reading of the following description in conjunction with the attached drawings, in which:

FIG. 1 is a view of an inside of a shield that is a first embodiment of the invention, showing a suspension strap unfastened and a canister being inserted;

FIG. 2 is a view showing the outside of the shield;

FIG. 3 is an enlarged view showing an officer's hand gripping the handle of the shield;

FIG. 4 is a view similar to FIG. 3 showing the officer's thumb triggering the canister;

FIG. 5 is an elevational view of the shield showing a warning on the outer surface of the shield;

FIG. 6 is a view showing the inside of the shield being carried on an officer's forearm;

FIG. 7 illustrates use of the shield with a baton;

FIG. 8 illustrates use of the shield with a baton and a canister;

FIG. 9 is an end view showing the inside of the shield being carried on an officer's forearm;

FIG. 10 is an elevational view similar to FIG. 5 with the shield being carried by an officer on the opposite arm and thus showing the warning in a reversed orientation; and

FIG. 11 is a view of a handle with a canister locking mechanism that is a second embodiment of the invention.

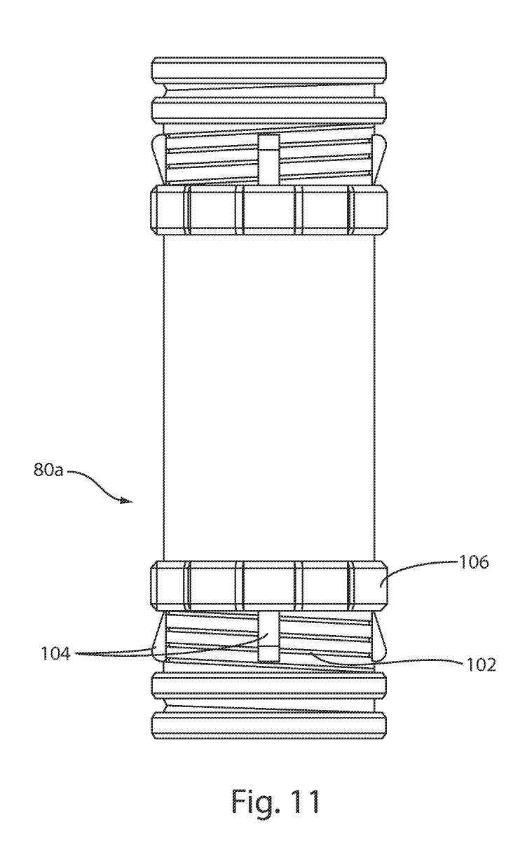

### DETAILED DESCRIPTION

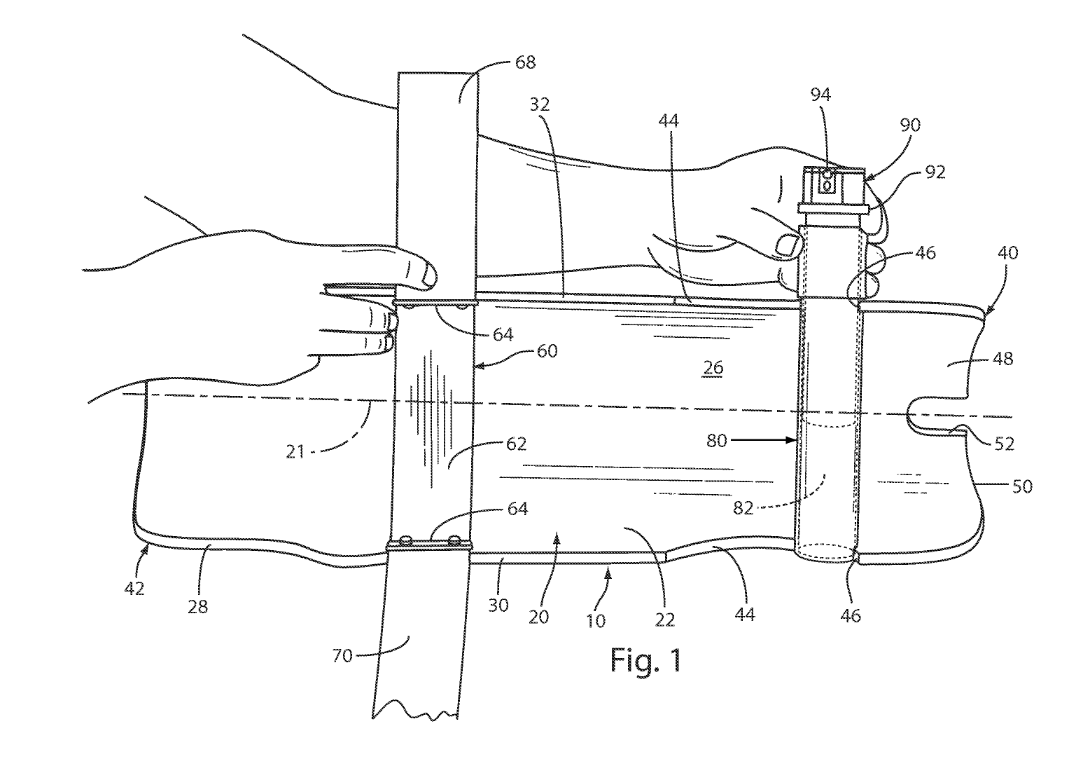

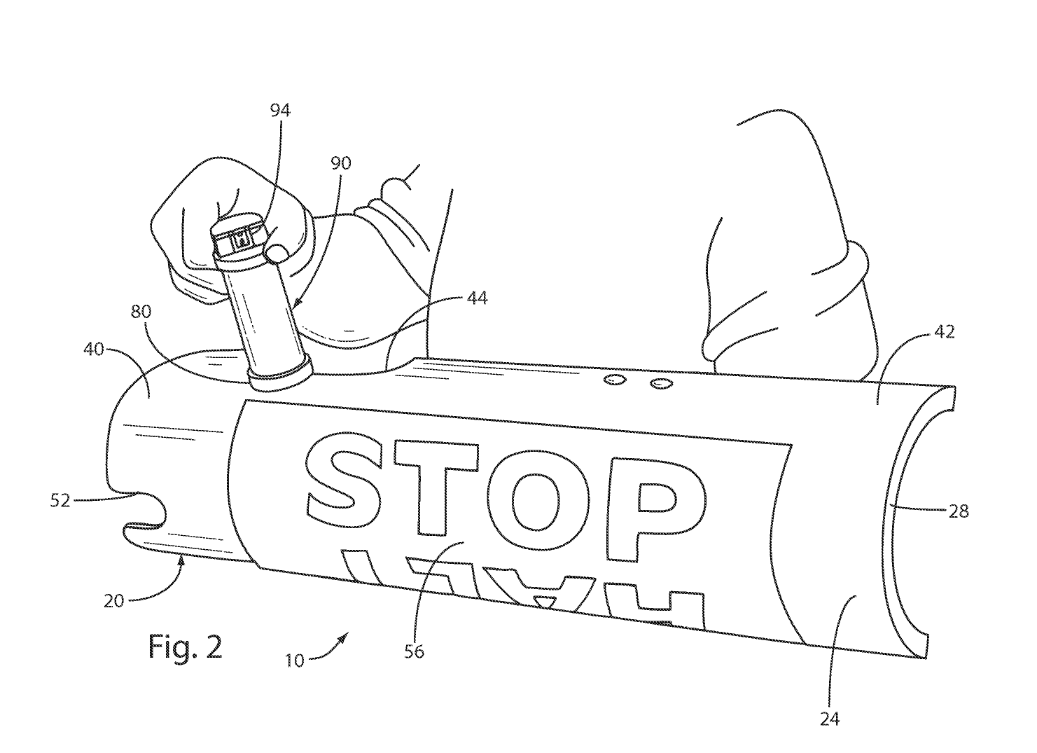

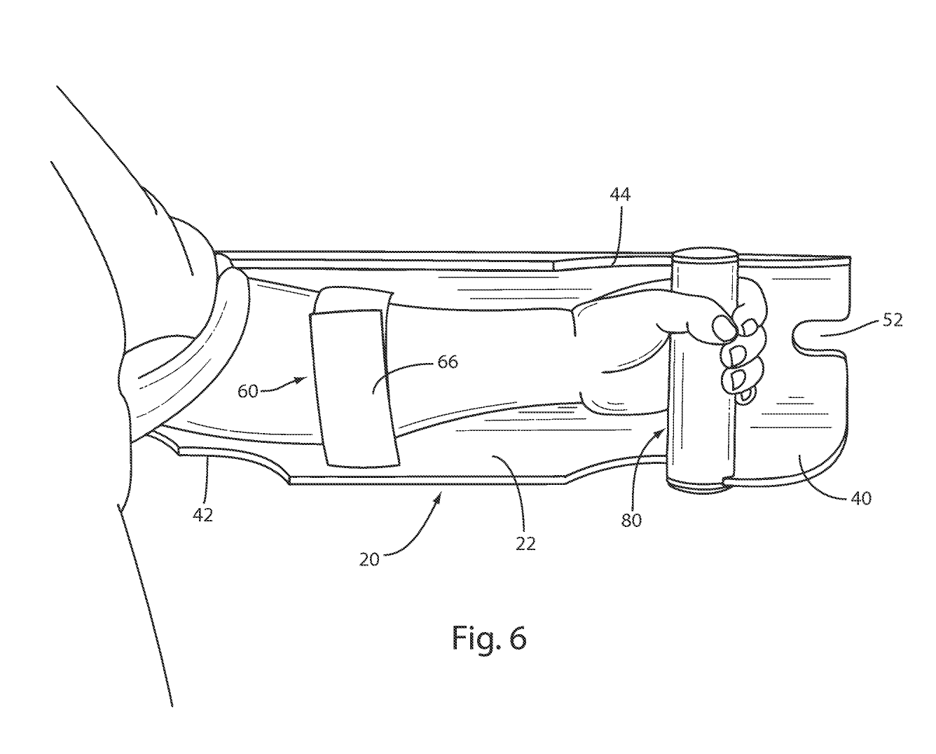

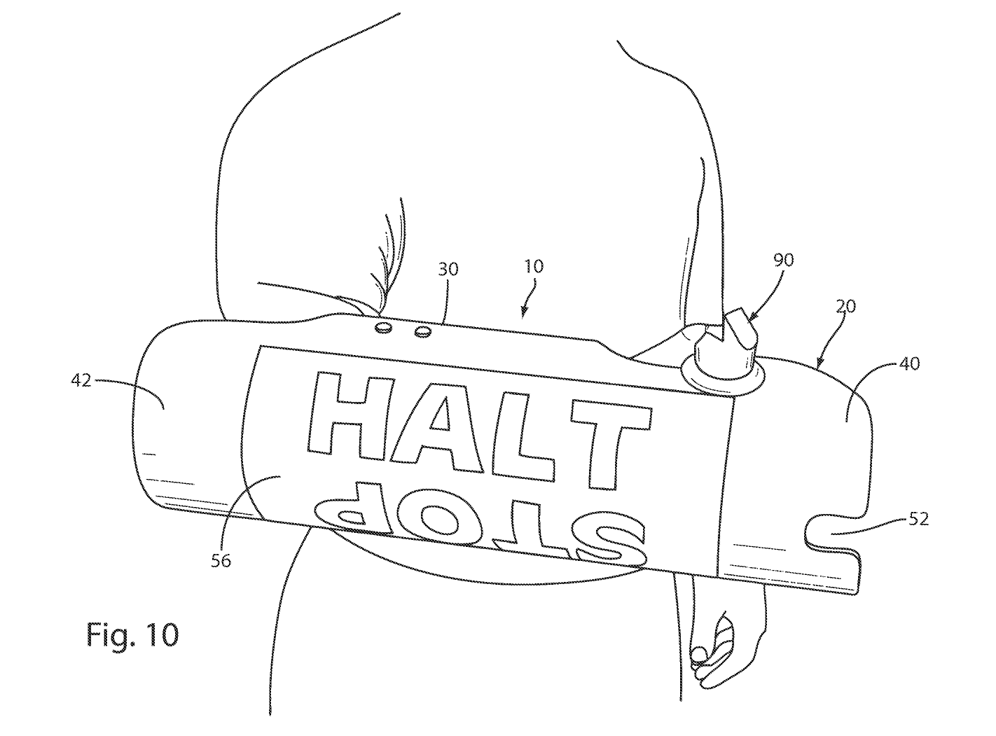

This invention relates to a shield and, in particular, to a portable shield for use by a peace officer, for example. The invention is applicable to shields of different configurations. As representative of the invention, FIGS. 1-10 illustrate a shield 10 that is a first embodiment of the invention.

The shield 10 includes a shield body 20 that is preferably made from a strong, lightweight plastic material, such as ABS plastic. The shield body 20 could alternatively be made from another material. The shield body 20 has an elongate, curved configuration, like a portion of a pipe or cylinder. The shield body 20 has a longitudinal central axis 21 about which the shield body is symmetrical.

The shield body 20 has a concave inner major side surface 22, on the concave inside of the shield body. The shield body 20 also has a convex outer major side surface 24, on the convex outside of the shield body, that extends parallel to the inner major side surface 22. The shield 10 has an interior space (volume) 26 which is bounded by the inner major side surface 22.

The inner and outer major side surfaces 22 and 24 of the shield body 20 are joined by a minor side surface (edge surface) 28 of the shield body. The edge surface 28 intersects the inner and outer major side surfaces 22 and 24 at edges of the shield body 20. The edge surface 28 extends completely around the length and width of the shield body 20. The edge surface 28 includes two major edge surface portions 30 and 32 that extend parallel to the longitudinal central axis 22 of the shield body, on opposite sides of the shield 10.

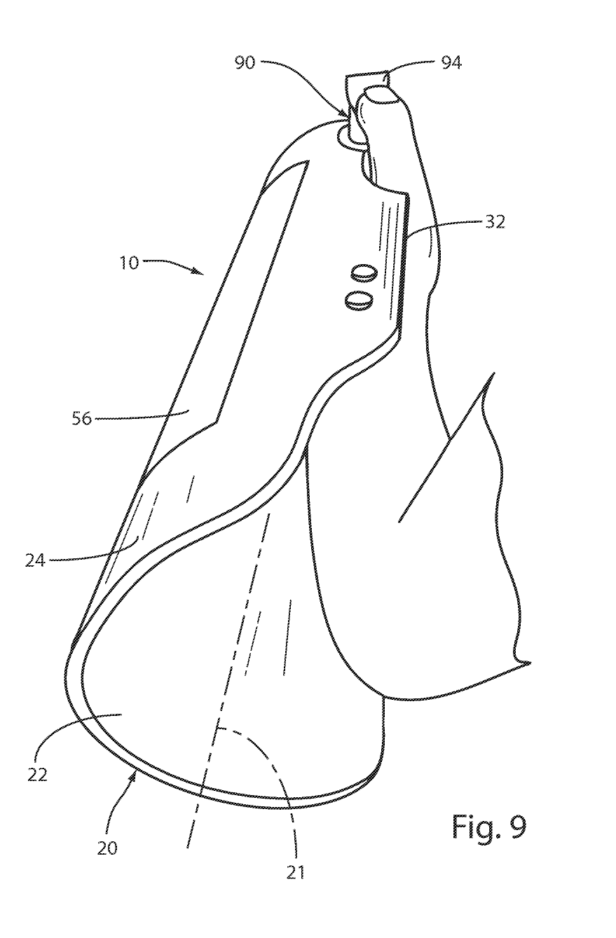

The curved configuration of the shield body 20 may be, but need not be, cylindrical. In the illustrated embodiment, the shield body 20 is not cylindrical. The shield body is “flattened” in a direction from left to right as viewed in FIG. 9, with the side edge portions 30 and 32 being spaced apart by a greater distance than the height of the shield body. The curved configuration of the shield body 20 may be centered generally on the longitudinal axis of the officer's forearm when the shield is being worn. The curved shape of the shield body tracks (conforms to) the curved shape of the officer's forearm. As a result, the shield 10 when worn becomes an extension of the forearm, or a “large forearm”.

The shield body 20 has a first end portion 40 (hand end) and a second end portion 42 (elbow end) located at opposite ends of the shield 10. At the first end portion 40 of the shield body 20, the edge surface 28 is recessed to form two thumb recesses 44 on opposite sides of the shield body, and two adjacent part-circular handle recesses 46. Farther toward the first terminal end 48 of the shield body, the edge surface 28 is curved inward to form a first end edge 50 of the shield body 20. In one embodiment, the shield body 20 has the following dimensions: length, 21 inches; width, 7 inches; height, 4 inches; material thickness, one half inch.

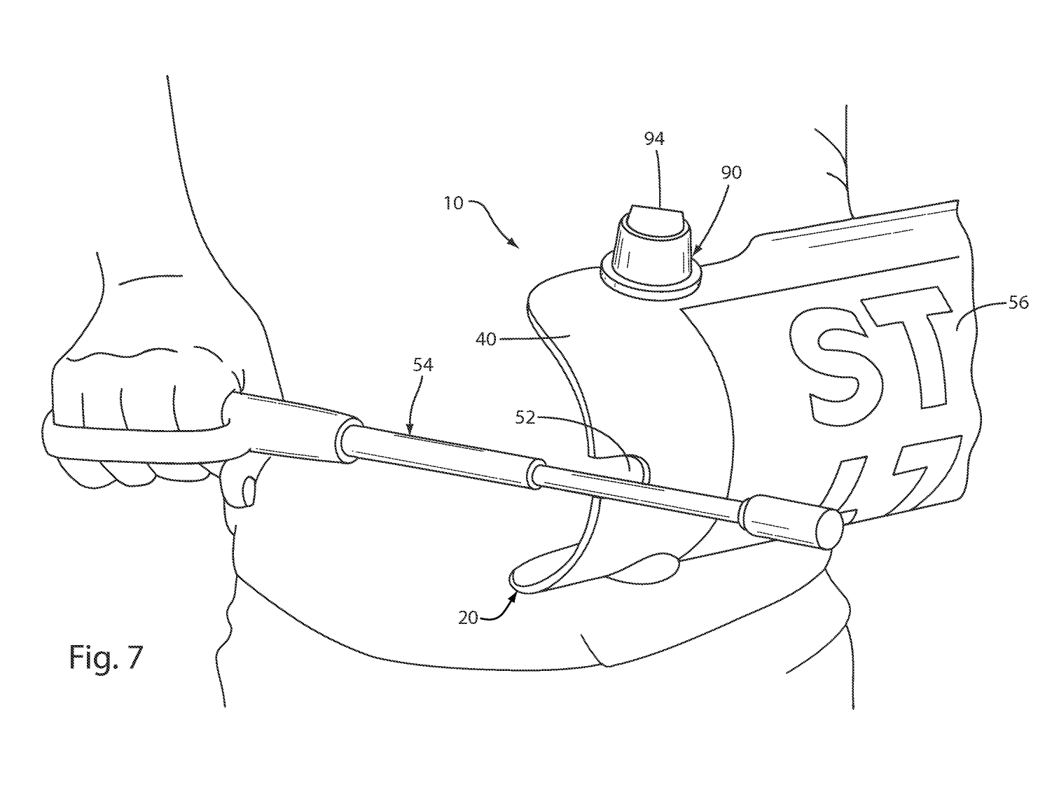

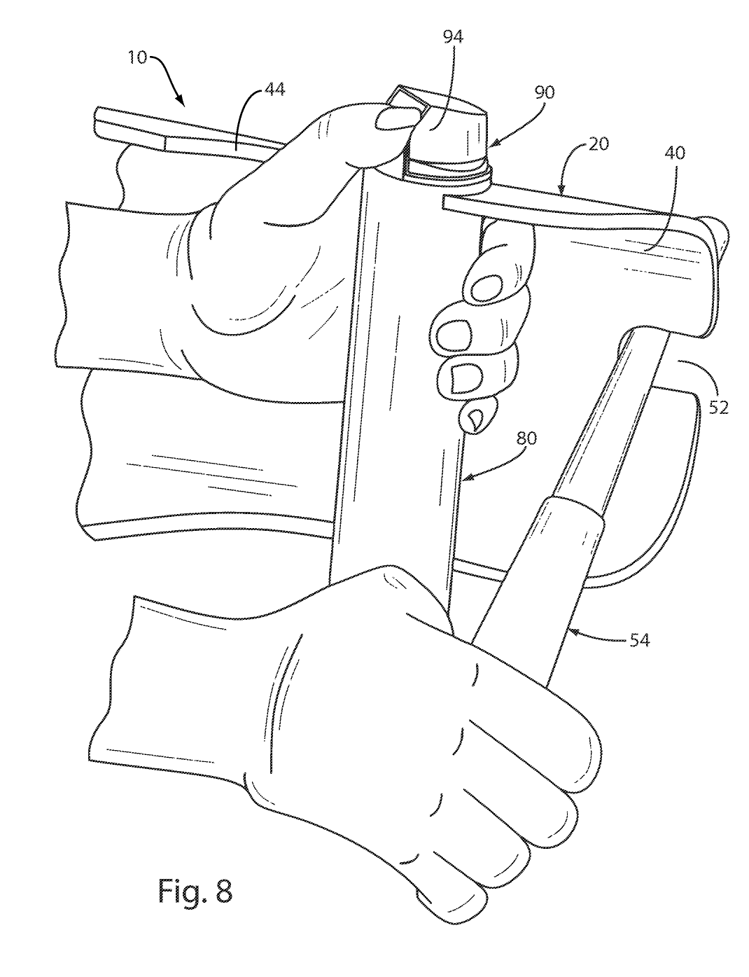

A baton port 52 is formed in the first end edge 50 of the shield body 20. The baton port 52 is a recess or slot in the shield body 20 that is configured and dimensioned to accept a peace officer's baton 54 (FIGS. 7 and 8). For example, the baton port 52 may be one and one-quarter inches across and one and one-half inches long. The baton port 52 can receive a portion of a baton 54, as described below, to help to support and guide the baton for two-handed baton operation. At the opposite second end portion 42 (elbow end) of the shield body 20, the edge surface 28 is recessed to provide clearance for an officer's elbow and upper arm when the officer's arm is flexed and extended.

On its outer surface 24, the shield body 20 preferably carries a warning 56 (to potential attackers). In the illustrated embodiment, the warning 56 is the words “Stop” and “Halt”. The two words are written opposite to each other (bottom to bottom). Each one of the two words Stop and Halt includes letters that have their bottom edges adjacent to the bottom edges of the letters in the other word. In this sense, the warning 56 can be said to be “mirrored” about an imaginary line extending between the two words. Thus, the word “stop” is right side up when the shield 10 is worn and held horizontally by a right-handed officer (on his left arm), with the other word “halt” being upside down. The word “halt” is right-side up when the shield 10 is worn and held horizontally by a left-handed officer (on his right arm), with the word “stop” being upside down. As a result, at least one of the two words on the shield 10 is clearly readable by an attacker when the shield is being worn and held horizontally by an officer. Other words can be used, of course, and the same word can be used twice if desired.

The mirrored wording arrangement of the warning 56 can aid the officer in donning the shield 10. Specifically, the shield body 20 is symmetrical from side to side (to provide an “ambidextrous” benefit) and it may in some circumstances be difficult to identify which end is which if the officer wants to quickly don the shield 10. The officer can, however, tell which end is which from the orientation of the warning 56. The officer can view the two differently oriented words and determine how to don the shield 10, without being able to see the inside of the shield.

The shield 10 includes a suspension strap 60. The suspension strap 60 aids in supporting the shield body 20 on the officer's forearm. The suspension strap 60 is an adjustable length strap that extends across the inside volume 26 of the shield 10 and that can be secured around the forearm of an officer (user of the shield).

A first (intermediate) portion 62 of the suspension strap 60 is fixedly connected to the shield body 20 by two rivet plates 64 and associated rivets, and has a fixed length. This first portion 62 of the suspension strap 60 is spaced inward from the inner side surface 22 of the shield body 20. The first portion 62 of the suspension strap 60 is preferably slightly longer than the distance between the two rivet plates 64; as a result, there is some in-and-out play (resilience) in the first portion of the suspension strap, relative to the shield body 20.

A second portion 66 of the suspension strap 60 extends from the rivet plates 64 and includes the two end portions 68 and 70 of the strap. The end portions 68 and 70 include means for securing the end portions together when the strap 60 is wrapped around the forearm. In the illustrated embodiment, the securing means is hook and loop (Velcro®) fasteners. The end portions 68 and 70 are configured to allow the second portion 66 of the strap 60 to be secured at different lengths, so as to accommodate different size forearms in the space between the first and second portions 62 and 66 of the suspension strap 60.

The shield 10 includes a handle 80. The handle 80 is preferably a rigid cylindrical tube with a central chamber 82. The handle 80 is permanently mounted in the two handle recesses 46 of the shield body 20. The ends of the handle 80 may be fastened to the shield body 20 with an adhesive, for example. The handle 80 thus extends across the inner volume of the shield.

The outside diameter of the handle 80 is configured to be easily and securely gripped by the support (non-firearm) hand of the officer. The inside diameter of the handle 80 is configured to receive closely a canister 90 of a sprayable protection material, such as pepper spray (OC) or mace. In one example, such a canister 90 has a diameter of about one and one-half inches.

The shield 10 includes a retainer 92 that retains the canister 90 in the handle 80. The retainer 92 may be on the handle 80, or on the canister 90, or partially on each. In the embodiment illustrated in FIGS. 1-10, the retainer 92 is on the canister 90 and constitutes an O-ring on the exterior of the canister. The O-ring 92 releasably secures the canister 90 in the chamber 82 of the handle 80 during use of the shield 10, while enabling easy replacement of the canister when needed.

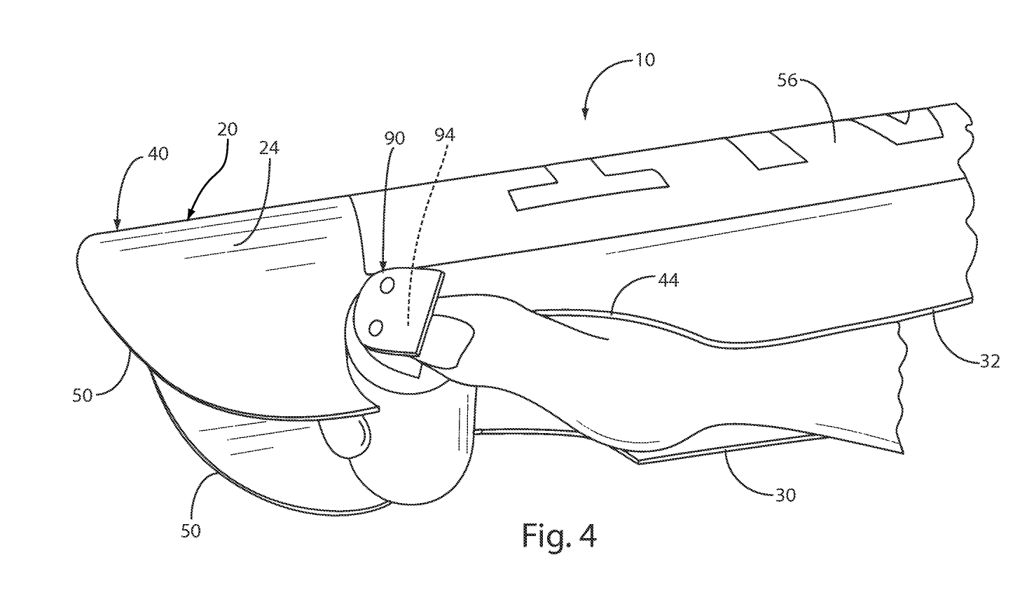

When the canister 90 is in the handle 80, the working end of the canister, including the actuator (trigger) 94, is adjacent one of the thumb recesses 44. The trigger 94 may be exposed or, as shown in FIG. 4, may be covered for safety until the canister 90 is ready to be used.

The handle 80 itself is preferably symmetrical end to end. Together with the symmetrical configuration of the shield body 20 itself, this feature makes the shield 10 as a whole “ambidextrous”. That is, the shield 10 can be used equally well by a left-handed person or by a right-handed person.

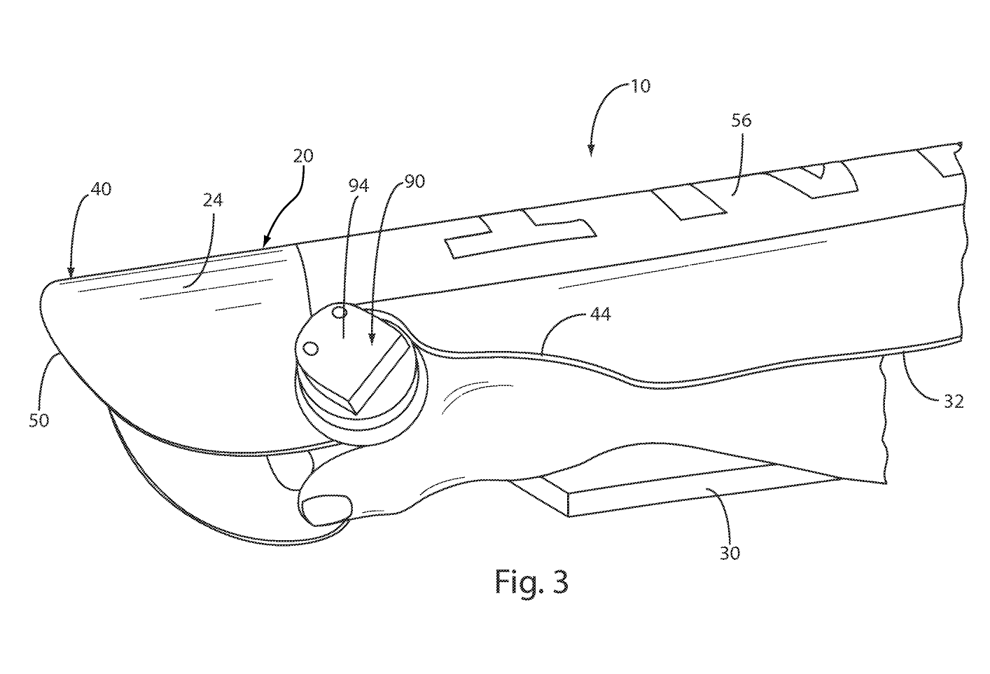

The shield 10 is used by supporting it on an officer's forearm. The officer grasps the handle 80 with the officer's supporting (non-firearm) hand. The officer may, if desired, secure the suspension strap 60 about the officer's forearm. If the two end portions 68 and 70 of the suspension strap 60 are already secured to each other, the officer can slip the officer's forearm through the suspension strap, between the first and second strap portions 62 and 66, and grasp the handle 80. When the shield 10 is thus supported on the forearm, as shown for example in FIG. 3, the officer's thumb is located adjacent to one of the thumb recesses 44.

The shield 10 acts as an extension of the officer's forearm. The officer can manipulate his arm, and strike with his arm, in substantially the same manner as if the officer were bare-handed. Specifically, the officer can execute empty-handed defensive and offensive skills (“fighting” moves) with the shielded arm. These might include, for example, a punch, a hammer fist, and a rear jab.

The curved configuration of the shield 10 follows the natural tendencies and movements of the officer's forearm. Thus, normal (already learned) hand-eye coordination is still applicable. The shield 10 thus acts like a “large forearm” (since it conforms to the natural shape of the forearm) so as not to hamper natural arm movements found in empty-hand (martial arts/DT) techniques for self-protection. In addition, the shield 10 is light in weight (about one pound) so it does not significantly slow down or encumber the officer's arm motions.

If necessary, the officer can easily disengage the officer's hand from the handle 80, or the arm from the entire shield 10, to perform other tasks. Thus, the officer can pull the forearm back a little in the suspension strap 60 and release the handle 80, so that the supporting hand is free to perform other tasks. The handle 80 can easily be regrasped when desired. Alternatively, the officer can set the tightness of the suspension strap 60 with enough play in it to enable the officer to quickly drop the shield 10 off his arm when a completely free hand or arm is needed.

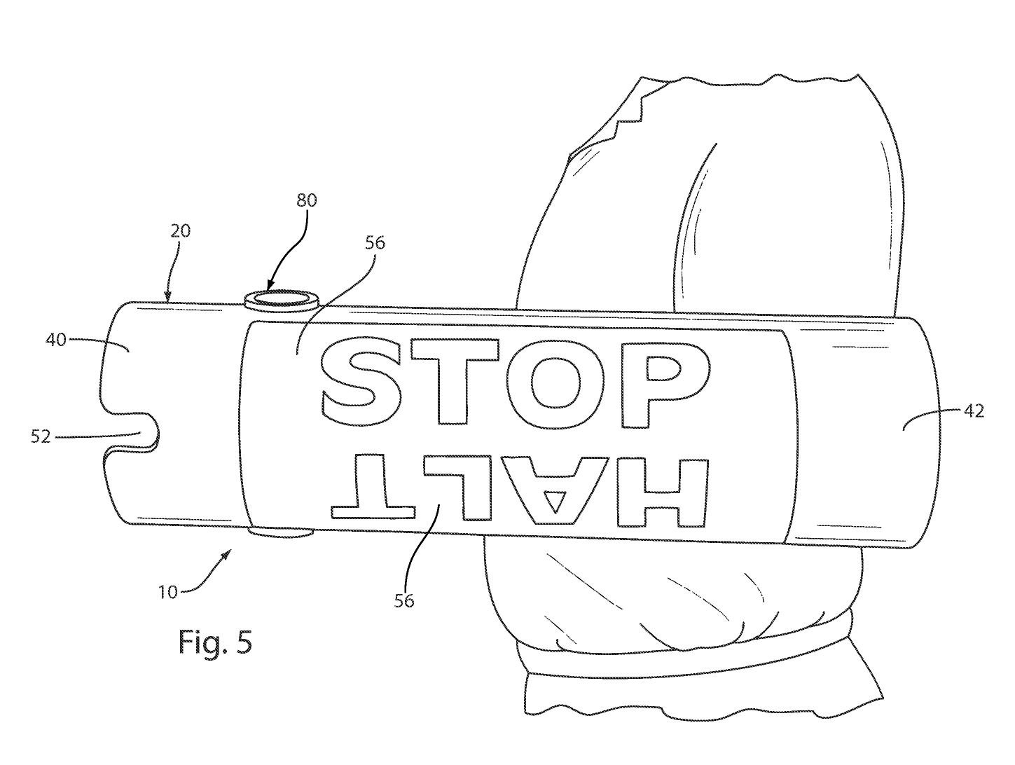

If the shield 10 were flat rather than curved it would be difficult to release the grip of an attacker who gripped the top edge of the shield body 20. In contrast, by making the body 20 of the shield 10 curved (for example, about a center line marking the middle of the forearm), a curved outer surface 24 is created. This curved surface or radius 24 can be used to apply counter-pressure to the undersurface of the attacker's wrist/forearm, whether he is grabbing with only one hand or both, thereby to bend it and cause the hand to be released. The curved or radiused surface 24 of the shield body 20 is used in a forceful upward rolling motion of the shield 10 (in a direction as indicated by the arrow 100 in FIG. 5) to cause the bending of the attacker's wrists/forearms (whether one or both are engaged), thus causing a weakening or releasing of the attacker's grip.

The curved or radiused outer side surface 24 also provides a contact area that is similar to the human forearm but larger and more rigid, for more effectiveness. Striking with a curved or radiused surface (as an analogy, in defensive tactics, a back fist, edge fist, or forearm strike) reduces injury potential to the recipient, as compared to what would be anticipated when a straight edge of similar thickness contacts the recipient of the strike.

The curved or radiused shield body 20 also makes it difficult for an attacker to grab the shield 10 and turn it against the officer, which is a common practice with standard or round riot shields, because of the shield's smaller overall size around the forearm. Specifically, with a larger or flat riot shield, an attacker can grab the shield to drive the upper edge into an officer's face (justification for officers wearing a face shield), or drive the shield down onto an officer's thigh near the knee to force that officer to the ground. And, after grabbing a typical riot shield, an attacker can drive the shield edge at the handle into the officer, while forcibly pulling with the other hand to take that officer off-balance and turn the officer around like a spinning top.

The shield 10 of the present invention is too small (short) and close to the body (the arm) to enable an attacker to grasp the shield and use it to pull the officer around. For example, if the attacker grabs the second end portion 42 of the shield (by the officer's elbow), the officer can drive the elbow back to pinch the attacker's hand between the shield end portion 42 and the officer's body.

The suspension strap 60 can significantly reduce the effects of shock coming through and into an officer's forearm, which shock might otherwise be strong enough to cause the officer to release the shield 10 due to the shock into the forearm. In prior art shields, the use of foam padding creates a natural channel of the shock to travel thought the shield and directly into an officer's forearm. In the shield 10, in contrast, the suspension strap 60 holds the officer's arm spaced apart from the shield body 20, and also is resilient, thus allowing movement of the shield body relative to the forearm when the shield body is struck.

For use of the spray canister 90, the thumb recesses 44 enable access to the canister trigger 94 without removing the hand from the handle 80. The officer can engage the trigger 94 of the canister 90 with the officer's thumb, for example as shown in FIG. 4. The officer can orient the officer's arm as a whole, with the shield 10, to direct the spray from the canister 90 in a particular direction. The officer can orient the canister 90 in the handle 80, ahead of time, so that the spray nozzle is pointed outward from the shield body 20, to facilitate rapid use of the canister spray against an attacker.

The baton port 52 can be compared to an oarlock on a rowboat. The edge surface of the shield body 20, extending around the baton port 52, acts like a fulcrum about which the baton 54 can be “levered”. This can provide a significant benefit to an officer wanting to use the end of the baton 54 to, for example, apply force to an object, such as a person or handcuffs on a person.

Thus, to use the baton port 52, the officer places the shaft of the baton 54 through the port, for example as shown in FIGS. 7 and 8, while grasping the handle of the baton with the dominant (firearm) hand. This can be done without releasing the handle 80. The baton shaft is captured in the port 52, and the baton 54 is thus effectively supported not only at its handle but also at a second point along its length. The officer can thus effect two-handed baton movements and forces by moving the shield 10 against an attacker, without removing the shield from the arm.

FIG. 12 illustrates an alternative embodiment of a retainer for the canister. In this embodiment, the handle 80a is externally threaded at 102. The handle also carries one or more locking members 104 in the form of spring loaded cams. A ring 106 is threaded on the handle thread 102 adjacent the cams 104. When a canister 90 is inserted into the handle 80a, it engages the cams 104. The ring 106 can be screwed into position along the handle 80a to lock the cams 104 down on the canister 90 to secure the canister in the handle. Other canister locking mechanisms (retainers) are possible, of course.

1. A protection device comprising:
an arm shield having a curved configuration to extend over and protect a forearm and hand of an officer, the arm shield having an outer major side surface and an inner major side surface, the inner major side surface defining an interior space of the arm shield for receiving the officer's forearm and hand;
the arm shield being curved about a longitudinal axis of the arm shield in a configuration conforming generally to the shape of a forearm;
the arm shield being symmetrical side to side thereby to enable use on either a left hand or a right hand; and
a rigid handle extending across the interior space of the arm shield for grasping by the officer's hand.

2. A protection device as set forth in claim 1 further including a resilient suspension strap spaced apart longitudinally along the arm shield from the handle for enclosing the forearm of the officer.

3. A protection device as set forth in claim 1 further including a canister of sprayable protection material removably received in a chamber in the handle, and wherein a trigger of the canister is positioned to be manually engageable by a thumb of an officer's hand for actuation by the officer when the canister is in the chamber in the handle.

4. A protection device as set forth in claim 1 wherein the shield has a baton port for receiving and guiding a baton.

5. A protection device as set forth in claim 1 wherein the shield has a warning, on its outer side surface, that is mirrored.

6. A protection device comprising:
an arm shield having a curved configuration to extend over and protect a forearm and hand of an officer, the arm shield having an outer major side surface and an inner major side surface, the inner major side surface defining an interior space of the arm shield for receiving the officer's forearm and hand;
a handle connected with the shield and extending across the interior space of the shield for grasping by the officer's hand to help support the shield, the handle defining a chamber in the handle; and
a canister of sprayable protection material removably received in the chamber in the handle.

7. A protection device as set forth in claim 6 wherein a trigger of the canister is positioned to be manually engageable by a thumb of the officer's hand for actuation by the officer when the canister is in the chamber in the handle.

8. A protection device as set forth in claim 6 including a retainer for retaining the canister in the handle to prevent removal of the canister from the handle.

9. A protection device as set forth in claim 8 wherein the retainer is an O-ring.

10. A protection device as set forth in claim 8 wherein the retainer is a mechanical gripping device.

11. A protection device as set forth in claim 6 wherein the shield and the handle are symmetrical so that the protection device is ambidextrous.

12. A protection device as set forth in claim 6 wherein the shield has a baton port for receiving and guiding a baton.

13. A protection device as set forth in claim 6 wherein the shield has a warning, on its outer side surface, that is mirrored.

14. A protection device comprising:
an arm shield having an outer major side surface and an inner major side surface, the inner major side surface defining an interior space of the arm shield for receiving an officer's forearm and hand, the shield having a handle in the interior space; and
a canister of sprayable protection material removably supported on the shield at a location in the interior space of the shield, the canister having a trigger that is manually engageable for actuation by the officer's hand when the officer's hand is on the handle in the interior space of the shield.

15. A protection device as set forth in claim 14 wherein the trigger is positioned to be manually engageable by a thumb of the officer's hand for actuation by the officer when the canister is in the chamber in the handle.

16. A protection device as set forth in claim 14 having a handle connected with the shield and extending at least partially across the interior space of the shield for grasping by the officer's hand to help support the shield, the handle defining a chamber in the handle, the canister being removably received in the chamber in the handle.

17. A protection device comprising:
an arm shield having a curved configuration to extend over and protect a forearm and hand of an officer, the arm shield having an outer major side surface and an inner major side surface, the inner major side surface defining an interior space of the arm shield for receiving the officer's forearm and hand;
the arm shield having a baton port for receiving and supporting a baton on the shield.

18. A protection device as set forth in claim 17 wherein the baton port is formed as a notch in an end of the shield that is sized to closely receive the baton so that the baton port acts as a fulcrum for the baton.

19. A protection device comprising:
an arm shield having a curved configuration to extend over and protect a forearm and hand of an officer, the arm shield having an outer major side surface and an inner major side surface, the inner major side surface defining an interior space of the arm shield for receiving the officer's forearm and hand, the arm shield being symmetrical side to side thereby to enable use on either a left hand or a right hand; and
a warning on the outer major side surface of the arm shield, the warning having a first part that is visible right side up when the shield is worn on the left hand and upside down when the shield is worn on the right hand, and having a second part that is visible right side up when the shield is worn on the right hand and upside down when the shield is worn on the left hand.

20. A protection device as set forth in claim 19 wherein the warning comprises two words each including letters that have their bottom edges adjacent to the bottom edges of the letters in the other word.

21. A protection device comprising:
an arm shield having a curved configuration to extend over and protect a forearm and hand of an officer, the arm shield having an outer major side surface and an inner major side surface, the inner major side surface defining an interior space of the arm shield for receiving the officer's forearm and hand;
a rigid handle fixed on the shield and extending at least partially across the interior space of the shield for grasping by the officer's hand to help support the shield; and
a resilient suspension strap for receiving and supporting the officer's forearm, the suspension strap including a first portion of fixed length extending between side portions of the arm shield at a location spaced inward from the inner major side surface and in the interior space, and a second portion that has a variable length for securing around the officer's forearm.

22. A protection device as set forth in claim 21 wherein the first portion of the suspension strap is slightly longer than the arm shield side portions to provide resilience in the first portion of the suspension strap relative to the arm shield.
